(19) United States
(12) Patent Application Publication
(10) Pub. No.: US 2023/0274053 A1
(43) Pub. Date: Aug. 31, 2023

(54) METHOD FOR DYNAMICALLY SIMULATING THERMAL RESPONSE OF BUILDING BY INTEGRATING A RATIO OF CONVECTION HEAT TO RADIATION HEAT OF HEATING TERMINAL

(71) Applicant: North China Electric Power University, Beijing (CN)

(72) Inventors: Baoping Xu, Beijing (CN); Qiangang Li, Beijing (CN); Zhuo Chen, Beijing (CN); Peihong Jiang, Beijing (CN)

(73) Assignee: North China Electric Power University, Beijing (CN)

(21) Appl. No.: 18/113,420

(22) Filed: Feb. 23, 2023

(30) Foreign Application Priority Data
Feb. 25, 2022 (CN) 202210175597.8

(51) Int. Cl. G06F 30/20; G06F 17/16

(52) U.S. Cl. CPC G06F 30/20; G06F 17/16; G06F 2119/08

(57) ABSTRACT

A method for dynamically simulating the thermal response of a building by integrating the ratio of convection heat to radiation heat of heating terminals is provided, and belongs to the technical field of building environments and heating, ventilation, and air conditioning (HVAC) systems. A room thermophysical model of a building to be simulated is constructed. The ratio of radiation heat at the heating terminal is used as a variable in the room heat balance matrix equation, which shows that different heating terminals have different thermal characteristics due to different ratios of convection heat to radiation heat. The room heat balance matrix equation is solved to obtain a room air temperature equation. By integrating a heating-terminal thermal characteristic equation with the room air temperature equation, thermal characteristics of the heating terminals are combined with thermal characteristics of the building, which improves accuracy of dynamic simulation on a heating system.

### CROSS REFERENCE TO RELATED APPLICATION

This patent application claims the benefit of priority under 35 U.S.C. § 119(a)-(d) of Chinese Patent Application No. 202210175597.8 filed in China on Feb. 25, 2022, the disclosure of which is incorporated by reference herein in its entirety as part of the present application.

### TECHNICAL FIELD

The present disclosure relates to the technical field of building environments and heating, ventilation, and air conditioning (HVAC), and in particular to a method for dynamically simulating a thermal response of a building by integrating a ratio of convection heat to radiation heat of heating terminals.

### BACKGROUND

For energy conservation and emission reduction, there is a growing demand to save energy of buildings. Thermal responses simulation of buildings is one of important research methods to realize efficient and demand response (DR) operation of the buildings, as it can analyze dynamic energy consumption and passive heat storage potential of the buildings and optimize operation control strategies of the buildings.

### SUMMARY

It is appreciated that to perform a thermal response simulation of buildings, the accuracy of a dynamic model is very important, which directly affects the accuracy of analysis on thermal response characteristics of the buildings and the reliability of optimization on operation strategies of the buildings. However, in conventional thermal environment simulation of buildings, heat emitting from a terminal device is often taken as convective heat which immediately affects the thermal state of indoor air. The above mentioned simulation method is applicable to convective heating terminals. But for convective-radiant heating terminals such as radiators, it is appreciated that the conventional simulation method cannot reflect radiation characteristics of the heat transfer between heating terminals and building envelopes, which causes a large deviation between dynamic simulation results and the actual operation data.

Some embodiments of the present disclosure relate to providing a method for dynamically simulating a thermal response of a building by integrating a ratio of convection heat to radiation heat of a heating terminal, to improve accuracy of dynamic simulation on a heating system.

According to some embodiments, the present disclosure provides the following technical solutions.

A method for dynamically simulating a thermal response of a building by integrating a ratio of convection heat to radiation heat of a heating terminal includes constructing a thermophysical room model of a building to be simulated, the thermophysical room model including a radiation heat transfer relationship and a convection heat transfer relationship of a heating terminal in a room, determining, according to the thermophysical room model, a room heat balance matrix equation considering a ratio of radiant heat emitting from the heating terminal, the ratio of radiant heat being a ratio of radiant heat from the heating terminal to a total amount of heat dissipation from the heating terminal, solving the room heat balance matrix equation according to the ratio of radiant heat at the heating terminal to obtain a room air temperature equation, constructing a heating-terminal thermal characteristic equation, determining a dynamic simulation equation for an air temperature of the room by integrating the heating-terminal thermal characteristic equation with the room air temperature equation, and calculating a room air temperature in the building to be simulated in real time, according to real-time heat supply parameters of the heating terminal and with the dynamic simulation equation for the air temperature of the room.

Optionally, the room thermophysical model includes heat release of the heating terminal and heat transfer between adjacent rooms, the heat release of the heating terminal includes convection heat transfer between the heating terminal and indoor air, and radiation heat transfer between the heating terminal and an inner surface of a building envelope enclosure, and the heat transfer between adjacent rooms includes convection heat transfer between an outer surface of a partition wall of the room and air of the adjacent room, and radiation heat transfer between the outer surface of the partition wall of the room and a heating terminal of the adjacent room.

Optionally, the determining, according to the room thermophysical model, a room heat balance matrix equation considering a radiant heat ratio at the heating terminal specifically includes constructing a boundary equation for an indoor envelope enclosure as

$$- λ F \frac{\partial t}{\partial x} {\vert}_{x = l} = {h}_{in} F ( {t}_{a} - t ) + {q}_{r} + {q}_{in} + fsb \cdot {q}_{hvac}$$

according to the room thermophysical model, where λ is a thermal conductivity coefficient of the envelope enclosure along a thickness direction, F is an inner surface area of the envelope enclosure, t is a temperature of the envelope enclosure, x is a thickness, x=l indicating that a thickness value is l, hᵢₙ is a convection heat transfer coefficient between an inner surface of the envelope enclosure and air, tₐ is an air temperature, qᵣ is heat absorbed by the inner surface of the envelope enclosure from solar radiation through a window, qᵢₙ is radiation heat gain absorbed by the inner surface of the envelope enclosure from indoor heat disturbance, q_{hvac} is a total heat transferred from the heating terminal to a building space, and fsb is the ratio of radiant heat, constructing a temperature variation equation for air in the room as

$${c}_{p a} {ρ}_{a} {V}_{a} \frac{dt}{d τ} = {\sum }_{m = 1}^{M} {F}_{m} {h}_{in} [ {t}_{m} ( τ ) - {t}_{a} ( τ ) ] + {q}_{cov} + {q}_{vent} + {fsb}_{a} {q}_{hvac}$$

according to the room thermophysical model, where cₚₐρₐVₐ is a total heat capacity of the air in the room, cₐ is a specific heat capacity of the air in the room, ρₐ is a density of the air in the room, Vₐ is a volume of the air in the room, Fₘ is an area of an inner surface m of the envelope enclosure, tₘ(τ) is a temperature of the inner surface m at time τ, tₐ(T) is an air temperature of the room at the time τ, M is a number of inner surfaces, q_{cov} is convective heat transferred from the indoor thermal disturbance, qᵥₑₙₜ is a heat transfer amount generated by ventilation between indoor and outdoor or adjacent rooms, and fsbₐ is a ratio of convective heat from the heating terminal to the total amount of heat dissipation from the heating terminal, and constructing, according to the boundary equation for the indoor envelope enclosure and the temperature variation equation for the air in the room, the room heat balance matrix equation considering the ratio of radiant heat from the heating terminal as C\dot{T}=AT+Bu, where C represents a matrix for a heat storage capacity of each node, T represents a matrix for a temperature of the node, A represents a matrix for a relationship of heat flows between adjacent nodes, B represents a matrix for interactions between each heat disturbance and the node, and u represents a matrix for heat disturbance acting on various nodes, wherein matrix B of the envelope enclosure i is

$${B}_{i} = ( \begin{matrix}0 & {h}_{in} {f}_{i} & {h}_{out} {f}_{i} & {fsb}_{j} & {S}_{i} & 0 & 0 & 0 & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{i} & 0 & 0 & 0 & 0 & {k}_{i} & {s}_{si} & {s}_{di} & 0 & 0\end{matrix} ) ,$$

where is matrix Bₜ of an envelope enclosure i, hᵢₙfᵢ and hₒᵤₜfᵢ are convection heat transfer of an outer surface of the envelope enclosure i with adjacent room air and outdoor air respectively, fsbⱼ is a ratio of radiant heat obtained by the envelope enclosure i from a heating terminal of the adjacent room to a total amount of heat emitting from the heating terminal of the adjacent room when the adjacent room serves as a heating room, Sᵢ is solar radiant heat obtained by the outer surface of the envelope enclosure i, kᵢ is the indoor heat obtained by an inner surface of the envelope enclosure i, sₛᵢ and s_{di} are the scattered heat and direct heat respectively obtained by the inner surface of the envelope enclosure i from the solar radiation through the window, and fsbᵢ is a ratio of radiant heat obtained by the envelope enclosure i to the total amount of heat emitting from the heating terminal,

$${fsb}_{i} = \frac{fsb \cdot \frac{{F}_{z}}{{F}_{fur} + {F}_{z}}}{6} ,$$

F_{z} is an internal surface area of an envelope enclosure except for the furniture, and F_{fur} is an equivalent radiation heat transfer surface area of the furniture.

Further, in some embodiments, Matrix B of the furniture is

$${B}_{fur} = ( \begin{matrix}{fsb}_{fur} & 0 & 0 & 0 & {S}_{fur 1} & {k}_{fur 1} & {s}_{s , fur 1} & {s}_{d , fur 1} & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{fur} & 0 & 0 & 0 & {S}_{furn} & {k}_{furn} & {s}_{s , furn} & {s}_{d , furn} & 0 & 0\end{matrix} ) ,$$

where B_{fur} is matrix B of the furniture, S_{fur1} is solar radiant heat obtained by one side surface of the furniture, S_{furn} is solar radiant heat obtained by the other side surface of the furniture, k_{fur1} is indoor heat obtained by one side surface of the furniture, k_{furn} is indoor heat obtained by the other side surface of the furniture, s_{s,fur1} and s_{d,fur1} are scattered heat and direct heat respectively obtained by one side surface of the furniture from the solar radiation through the window, s_{s,furn} and s_{d,furn} are scattered heat and direct heat respectively obtained by the other side surface of the furniture from the solar radiation through the window, and fsb_{fur} is a ratio of radiant heat obtained by the furniture to the total amount of heat emitting from the heating terminal,

$${fsb}_{fur} = \frac{fsb}{2} \cdot \frac{{F}_{fur}}{{F}_{fur} + {F}_{z}} .$$

Further, in some embodiments, Matrix B of the air is Bₐ=(fsbₐ 0 0 0 0 kₐ 0 0 1 1), where Bₐ is matrix B of the air, kₐ is indoor heat obtained by the air, and fsbₐ is a ratio of the convection heat transfer amount obtained by the air to the total amount of heat dissipation from the heating terminal, fsbₐ=1−fsb, and the heat disturbance matrix u is U=(q_{heat supply} t_{air temperature of adjacent room} t_{outdoor temperature} q_{heat supply of adjacent room} q_{solar radiation} q_{internal heat} q_{scattered heat via window} q_{direct heat via window} q_{ventilation of adjacent rooms} q_{outdoor ventilation})^{T}, where q_{heat supply} is heat supply amount from the heating terminal in the calculated room, t_{air temperature of adjacent room} is the air temperature of the adjacent room, t_{outdoor temperature} is the outdoor temperature, q_{heat supply of adjacent room} is heat supply amount from the heating terminal of the adjacent room, q_{solar radiation} is the solar radiant heat, q_{internal heat} is the amount of heat generation in the room except the heating terminal, q_{scattered heat via window} is the scattered heat from solar radiation irradiated into the room through the window, q_{direct heat via window} is the direct heat from solar radiation irradiated into the room through the window, q_{ventilation of adjacent rooms} is the heat transfer amount generated by ventilation between the adjacent rooms, and q_{outdoor ventilation} is the heat transfer amount generated by outdoor ventilation.

Optionally, the room temperature equation is expressed as:

tₐ(τ)=t_{b2}(τ)+ΦᵥₑₙₜcₚρGₒᵤₜ(τ)(tₒᵤₜ(τ)−tₐ(τ))+Φ_{hvac}Q(τ)

where t_{bz}(τ) is air temperature of the room without considering natural ventilation and heat emitting from the heating terminal at current time, Φᵥₑₙₜ is the influence coefficient of outdoor ventilation on the air temperature at the current time, cₚ and ρ are the specific heat and density of the air respectively, Gₒᵤₜ(τ) is the outdoor air ventilation rate, tₒᵤₜ(τ) is the outdoor temperature at the current time, Φ_{hvac} is the influence coefficient of the heat supply amount on the air temperature, and Q(τ) is heat supply amount from the heating terminal at the current time,

$${t}_{bz} ( τ ) = {\sum }_{r} {e}^{{λ}_{r} Δ τ} {t}_{ar} ( τ - Δ τ ) + {\sum }_{k} ( {Φ}_{k , 1} {u}_{k} ( τ - Δ r ) + {Φ}_{k , θ} {u}_{k} ( r ) ) + {\sum }_{j} ( {Φ}_{j , 1} {t}_{j} ( τ - 2 Δ τ ) + {Φ}_{j , θ} {t}_{j} ( τ - Δ τ ) ) + {\sum }_{j} ( {Φ}_{i , j , 1} {Q}_{j} ( τ - 2 Δ τ ) + {Φ}_{i , j , 0} {Q}_{j} ( τ - Δ τ ) ) ,$$

where λᵣ is the eigenvalue obtained by performing orthogonal transformation on the eigenvector of a matrix \sqrt{C}⁻¹A\sqrt{C}⁻¹, tₐᵣ(τ−Δτ) is a component of the air temperature tₐ(τ−Δτ) at previous time corresponding to λᵣ, uₖ corresponds to a k-th element in the heat turbulence matrix u, Φ_{k,1} and Φ_{k,0} are influence coefficients of other heat turbulence on the air temperature at the previous time and the current time respectively, Φ_{j,1} and Φ_{j,0} are the first and second influence coefficients of the air temperature of an adjacent room j on the air temperature of the calculated room respectively, tⱼ is the temperature of the adjacent room j, Φ_{l,j,1} and Φ_{l,j,0} are first and second influence coefficients of heat supply amount in the adjacent room j on the air temperature of the room respectively, and Qⱼ is heat supply amount from a heating terminal of the adjacent room j.

Optionally, the heating-terminal thermal characteristic equation is expressed as:

Q(τ)=K(tₚ(τ)−tₐ(τ))

where Q(τ) is the heat supply amount from the heating terminal at the time τ, K is a complex heat transfer coefficient characterizing the heat transfer capability of the heating terminal, and tₚ(τ) is an equivalent temperature for the heat transfer capability of the heating terminal influenced by the supply water temperature and the flow rate.

Optionally, the dynamic simulation equation for the air temperature of the room is expressed as

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {Kt}_{p} ( τ )}{1 + {Φ}_{vent} {c}_{p} ρ {G}_{out} ( τ ) + {Φ}_{hvac} K} .$$

Optionally, when the heating terminal is a fan coil, the dynamic simulation equation for the air temperature of the room is expressed as

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} ε {C}_{min} ( τ ) {t}_{g} ( τ )}{1 + {Φ}_{vent} {c}_{p} ρ {G}_{out} ( τ ) + {Φ}_{hvac} ε {C}_{min} ( τ )} ,$$

where ϵ is heat transfer efficiency of the fan coil, Cₘᵢₙ(τ) is the minimum value of the heat capacity of water and air in the fan coil at the time τ, and t_{g}(τ) is the supply water temperature at the time τ,

when the heating terminal is a radiator, the dynamic simulation equation for the air temperature of the room is expressed as

$${t}_{a} ( τ ) = \frac{{t}_{b z} ( τ ) + {Φ}_{v e n t} {c}_{p} ρ {G}_{out} ( τ ) {t}_{out} ( τ ) + {Φ}_{hvac} {K}^{′} {F}_{r} {t}_{p} ( τ )}{1 + {Φ}_{v e n t} {c}_{p} ρ {G}_{out} ( τ ) + {Φ}_{h v a c} {K}^{′} {F}_{r}} ,$$

where K′ is the complex heat transfer coefficient of the radiator, Fᵣ is the equivalent heat transfer area of the radiator, and tₚ(τ) is the average surface temperature of the radiator at the time τ, and when the heating terminal is a radiant floor, the dynamic simulation equation for the air temperature of the room is expressed as

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {hF}_{f} {t}_{pf} ( τ )}{1 + {Φ}_{vent} {c}_{p} ρ {G}_{out} ( τ ) + {Φ}_{hvac} {hF}_{f}} ,$$

where F_{f} is the equivalent heat transfer area of the radiator, t_{pf}(τ) is the average surface temperature of the radiator at the time τ, and h is the complex heat transfer coefficient of the radiant floor, h=hᵣ+h_{c}, hᵣ is an equivalent radiation heat transfer coefficient, and h_{c} is a convection heat transfer coefficient.

A system for dynamically simulating the thermal response of a building by integrating the ratio of convection to radiation of a heating terminal includes a room thermophysical model constructing module configured to construct room thermophysical models of a building to be simulated, including the radiation heat transfer relationship and the convection heat transfer relationship of the heating terminal in a room, a room heat balance matrix equation determining module configured to determine, according to the room thermophysical model, the room heat balance matrix equation considering the ratio of radiant heat at the heating terminal, the ratio of radiant heat being a ratio of radiant heat from the heating terminal to the total amount of heat dissipation from the heating terminal, a room temperature equation obtaining module configured to solve the room heat balance matrix equation on the basis of the ratio of radiation heat at the heating terminal to obtain a room temperature equation, a heating-terminal thermal characteristic equation constructing module configured to construct a heating-terminal thermal characteristic equation, an air temperature equation determining module configured to determine a dynamic simulation equation for the air temperature of the room by integrating the heating-terminal thermal characteristic equation with the room temperature equation, and a room simulated temperature calculating module configured to calculate a simulated room temperature in the building to be simulated in real time, according to the dynamic simulation equation for the air temperature of the room and the real-time heat supply parameters of the heating terminal, such as meteorological parameters and the heat supply parameters of the adjacent rooms, etc.

Optionally, the room heat balance matrix equation determining module includes a boundary equation constructing submodule configured to construct a boundary equation for an indoor envelope enclosure as

$$- λ F \frac{\partial t}{\partial x} {\vert}_{x = l} = {h}_{in} F ( {t}_{a} - t ) + {q}_{r} + {q}_{in} + f sb \cdot {q}_{hvac}$$

according to the room thermophysical model, where λ is the thermal conductivity coefficient of the envelope enclosure along a thickness direction, F is the inner surface area of the envelope enclosure, t is the temperature of the envelope enclosure, x is the thickness, x=l indicating that the thickness value is l, hᵢₙ is the convection heat transfer coefficient between an inner surface of the envelope enclosure and the air, tₐ is the air temperature, qᵣ is the heat absorbed by the inner surface of the envelope enclosure from solar radiation through a window, qᵢₙ is heat gain absorbed by the internal surface of the envelope enclosure from radiation of the indoor heat disturbance, q_{hvac} is heat transferred from the heating terminal to the building space, and fsb is the ratio of the radiant heat, a temperature variation equation constructing submodule configured to construct a temperature variation equation for air in the room as

$${c}_{pa} {ρ}_{a} {V}_{a} \frac{{dt}_{a}}{d τ} = {\sum }_{m = 1}^{M} {F}_{m} {h}_{in} [ {t}_{m} ( τ ) - {t}_{a} ( τ ) ] + {q}_{cov} + {q}_{vent} + {fsb}_{a} {q}_{hvac}$$

according to the room thermophysical model, where cₚₐρₐVₐ is the total heat capacity of the air in the room, cₐ is the specific heat capacity of the air in the room, ρₐ is the density of the air in the room, Vₐ is the volume of the air in the room, Fₘ is the area of an inner surface m of the envelope enclosure, tₘ(τ) is the temperature of the inner surface m at time τ, tₐ(τ) is the room temperature at the time τ, M is the number of inner surfaces, q_{cov} is the heat transferred from the indoor heat disturbance to the air in a convective manner, qᵥₑₙₜ is the heat transfer amount generated by indoor and outdoor ventilation or ventilation between adjacent rooms, and fsbₐ is the ratio of convective heat from the heating terminal to the total amount of heat dissipation from the heating terminal, and a room heat balance matrix equation constructing submodule configured to construct, according to the boundary equation for the indoor envelope enclosure and the temperature variation equation for the air in the room, the room heat balance matrix equation considering the ratio of radiant heat at the heating terminal as C\dot{T}−AT+Bu, where C represents a matrix for the heat storage capacity of each node, T represents a matrix for the temperature of each node, A represents a matrix for the relationship of heat flows between adjacent nodes, B represents a matrix for interactions between each heat disturbance and the node, and u represents the matrix of heat disturbances acting on each node, where matrix B of the envelope enclosure is

$${B}_{i} = ( \begin{matrix}0 & {h}_{in} {f}_{i} & {h}_{out} {f}_{i} & {fsb}_{j} & {S}_{i} & 0 & 0 & 0 & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{i} & 0 & 0 & 0 & 0 & {k}_{1} & {s}_{si} & {s}_{di} & 0 & 0\end{matrix} ) ,$$

where Bᵢ is matrix B of the envelope enclosure i, hᵢₙfᵢand hₒᵤₜfᵢ hour are convection heat transfer of an outer surface of the envelope enclosure i with the adjacent room air and the outdoor air respectively, fsbⱼ is the ratio of radiant heat obtained by the envelope enclosure i from a heating terminal of the adjacent room to the total amount of heat emitting from the heating terminal of the adjacent room when the adjacent room serves as a heating room, Sᵢ is the solar radiant heat obtained by the outer surface of the envelope enclosure i, kᵢ is indoor heat obtained by an inner surface of the envelope enclosure i, sₛᵢ and s_{di} are scattered heat and direct heat obtained by the inner surface of the envelope enclosure i from the solar radiation through the window respectively, and fsbᵢ is the ratio of radiant heat obtained by the envelope enclosure i to the total amount of heat emitting from the heating terminal,

$${fsb}_{i} = \frac{fsb \cdot \frac{{F}_{x}}{{F}_{fur} + {F}_{z}}}{6} ,$$

F_{z} is the inner surface area of the envelope enclosure except for the furniture, and F_{fur} is the equivalent radiation heat transfer surface area of the furniture.

In some embodiments, Matrix B of the furniture is

$${B}_{fur} = ( \begin{matrix}{fsb}_{fur} & 0 & 0 & 0 & {S}_{fur 1} & {k}_{fur 1} & {s}_{s , fur 1} & {s}_{d , fur 1} & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{fur} & 0 & 0 & 0 & {S}_{furn} & {k}_{furn} & {s}_{s , furn} & {s}_{d , furn} & 0 & 0\end{matrix} ) ,$$

where B_{fur} is matrix B of the furniture, S_{fur1} is solar radiant heat obtained by one side surface of the furniture, S_{furn} is solar radiant heat obtained by the other side surface of the furniture, k_{fur1} is indoor heat obtained by one side surface of the furniture, k_{furn} is indoor heat obtained by the other side surface of the furniture, s_{s,fur1} and s_{d,fur1} are scattered heat and direct heat obtained by the one side surface of the furniture from the solar radiation through the window respectively, s_{s,furn} and s_{d,fur1} are scattered heat and direct heat obtained by the other side surface of the furniture from the solar radiation through the window respectively, and fsb_{fur} is the ratio of radiant heat obtained by the furniture to the total amount of heat emitting from the heating terminal,

$${fsb}_{fur} = \frac{fsb}{2} \cdot \frac{{F}_{fur}}{{F}_{fur} + {F}_{z}} .$$

In some embodiments, Matrix B of the air is Bₐ=(fsbₐ 0 0 0 0 kₐ 0 0 1 1), where Bₐ is matrix B of the air, kₐ is indoor heat obtained by the air, and fsbₐ is the ratio of the convection heat transfer amount obtained by the air to the total amount of heat dissipation from the heating terminal, fsbₐ=1−fsb, and the heat disturbance has the matrix u of u=(q_{heat supply} t_{temperature of adjacent room} t_{outdoor temperature} q_{heat supply of adjacent room}q_{solar radiation} q_{internal heat} q_{scattered heat via window} q_{direct heat via window} q_{ventilation of adjacent rooms} q_{outdoor ventilation})^{T}, where q_{heat supply} is heat supply amount from the heating terminal, t_{temperature of adjacent room} is the temperature of the adjacent room, t_{outdoor temperature} is the outdoor temperature, q_{heat supply of adjacent room} is heat supply amount from the heating terminal of the adjacent room, q_{solar radiation} is the solar radiant heat, q_{internal heat} is the amount of heat generation in the room except for the heating terminal, q_{scattered heat via window} is the scattered heat of solar radiation irradiated into the room through the window, q_{direct heat via window} is the direct heat of solar radiation irradiated into the room through the window, q_{ventilation of adjacent rooms} is the heat transfer amount generated by ventilation of the adjacent rooms, and q_{outdoor ventilation} is the heat transfer amount generated by outdoor ventilation.

Optionally, the dynamic simulation equation for the air temperature of the room is expressed as

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {Kt}_{p} ( τ )}{1 + {Φ}_{vent} {c}_{p} ρ {G}_{out} ( τ ) + {Φ}_{hvac} K} :$$

where tₐ(τ) is the air temperature of the room at the time τ, t_{bz}(τ) is the temperature of the room without considering heat supply amount from the heating terminal and natural ventilation at current time, Φᵥₑₙₜ is the influence coefficient of outdoor ventilation on the air temperature at the current time, Cₚ and ρ are the specific heat and density of the air respectively, Gₒᵤₜ(τ) is the ventilation rate between the room and the outside, tₒᵤₜ(τ) is the outdoor temperature at the current time, Φ_{hvac} is the influence coefficient of the heat supply amount on the air temperature of the room, K is an overall heat transfer coefficient characterizing the heat transfer capability of the heating terminal, and tₚ(τ) the equivalent temperature for the heat transfer capability of the heating terminal influenced by supply water temperature and flow rate.

According to the specific embodiments of the present disclosure, the embodiments of the present disclosure discloses the following technical effects.

The present disclosure provides the method for dynamically simulating the thermal response of a building by integrating the ratio of convection heat to radiation heat of heating terminals. The room thermophysical model of a building to be simulated is constructed. The proportion of radiation heat at a heating terminal is used as a variable in the room heat balance matrix equation, such that different heating terminals reflect different thermal characteristics in heating because of their diverse ratios of convection to radiation. The room heat balance matrix equation is solved to obtain a room air temperature equation. By integrating the heating-terminal thermal characteristic equation with the room air temperature equation, the thermal characteristics of the heating terminal are combined with thermal characteristics of the building, which improves accuracy of dynamic simulation on a heating system.

### BRIEF DESCRIPTION OF THE DRAWINGS

To describe the technical solutions in the embodiments of the present disclosure or in the prior art more clearly, the appended drawings required for the embodiments are briefly described below. Apparently, the appended drawings in the following description show merely some embodiments of the present disclosure, and those of ordinary skill in the art may still derive other appended drawings from these appended drawings without creative efforts.

FIG. 1 is a schematic diagram of a method for dynamically simulating the thermal response of a building by coupling the ratio of convection heat to radiation heat of heating terminals according to the present disclosure;

FIG. 2 illustrates a plan view of a residence according to an embodiment of the present disclosure;

FIG. 3 illustrates a diagram of a room thermophysical model according to an embodiment of the present disclosure; and

FIG. 4 illustrates a comparison between the simulation result considering the ratio of radiant heat and the measured air temperature according to an embodiment of the present disclosure.

### DETAILED DESCRIPTION OF THE EMBODIMENTS

The technical solutions of the embodiments of the present disclosure are clearly and completely described below in combination with reference to the appended drawings. Apparently, the described embodiments are merely a part rather than all of the embodiments of the present disclosure. All other embodiments obtained by those of ordinary skill in the art based on the embodiments of the present disclosure without creative efforts shall fall within protection scope of the present disclosure.

An objective of embodiments of the present disclosure is to provide a method for dynamically simulating the thermal response of a building by integrating the ratio of convection heat to radiation heat of a heating terminal, so as to improve accuracy of dynamic simulation of a heating system.

In order to make the above objectives, features, and advantages of the present disclosure more readily understood, the present disclosure will be further described in detail below with reference to the appended drawings and specific embodiments.

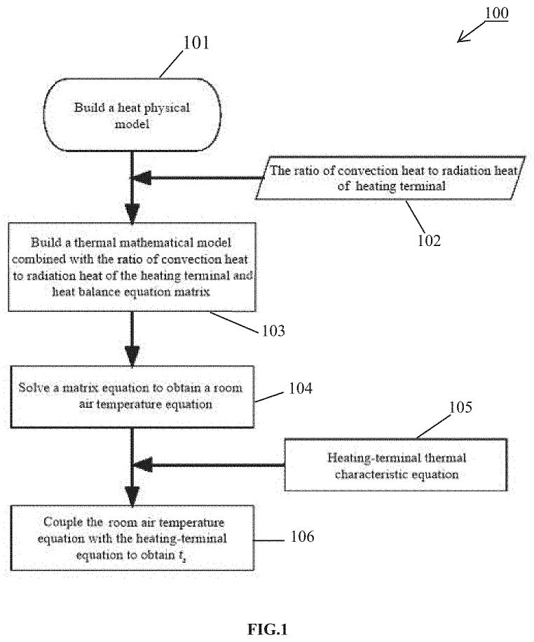

As shown in FIG. 1, the present disclosure provides a process 100 for dynamically simulating the thermal response of a building by integrating the ratio of convection heat to radiation heat of heating terminals, the method includes a plurality of processing steps.

In element 101, the room thermophysical model of a building to be simulated is constructed, the room thermophysical model including the radiation heat transfer relationship and the convection heat transfer relationship of the heating terminal in a room.

Based on analyzing the influences of different heat disturbances on temperature nodes of the building, the technical solution focuses on heat release of a heating terminal device, which includes convection heat transfer between the heating terminal device and indoor air, and radiation heat transfer between the heating terminal device and an inner surface of a building envelope enclosure. For influences of adjacent rooms, considerations are mainly given to calculate convection heat transfer between an outer surface of a partition wall of the room and air of the adjacent room and calculate radiation heat transfer between the outer surface of the partition wall of the room and the heating terminal of the adjacent room.

In element 103, according to the room thermophysical model, a room heat balance matrix equation considering the ratio of radiant heat from the heating terminal is determined. The ratio of radiant heat is a ratio of radiant heat to the total amount of heat dissipation in the heat dissipated from the heating terminal.

In element 102, the ratio fsb of radiant heat, namely the ratio of radiant heat to the total amount of heat dissipation in the heat dissipated from the heating terminal, is defined so as to characterize the ratios of convection heat to radiation heat at different heating terminals.

In an example implementation, the step specifically includes one or more calculations as follows.

In element 103, a thermal mathematical model is built combined with the ratio of convection heat to radiation heat of the heating terminal and a heat balance equation matrix. A boundary equation of an indoor envelope enclosure is constructed as

$$- λ F \frac{\partial t}{\partial x} {\vert}_{x = l} = {h}_{in} F ( {t}_{a} - t ) + {q}_{r} + {q}_{in} + f sb \cdot {q}_{hvac}$$

according to the thermophysical model of the room, where λ is the thermal conductivity coefficient of the envelope enclosure along the thickness direction, with a unit of W/(m·K); F is the inner surface area of the envelope enclosure, with a unit of m²; t is the temperature of the envelope enclosure, with a unit of ° C.; x is the thickness, with a unit of m, where x=l indicating that the thickness value is l; hᵢₙ is the convection heat transfer coefficient between the inner surface of the envelope enclosure and the air, with a unit of W/(m²·K); to is the air temperature, with a unit of ° C.; qᵣ is the heat absorbed by the inner surface of the envelope enclosure from solar radiation through a window, with a unit of W; qᵢₙ is the heat absorbed by the inner surface of the envelope enclosure from radiation of the indoor heat disturbance; q_{hvac} is heat transferred from the heating terminal to the building space, with a unit of W; and fsb is the proportion of radiant heat.

A temperature variation equation for air in the room is constructed as

$${c}_{pa} {ρ}_{a} {V}_{a} \frac{{dt}_{a}}{d τ} = {\sum }_{m = 1}^{M} {F}_{m} {h}_{in} [ {t}_{m} ( τ ) - {t}_{a} ( τ ) ] + {q}_{cov} + {q}_{vent} + {fsb}_{a} {q}_{hvac}$$

according to the room thermophysical model, where cₚₐρₐVₐ is the total heat capacity of the air in the room, with a unit of J/° C.; cₚₐ is the specific heat capacity of the air in the room; ρₐ is the density of the air in the room; Vₐ is the volume of the air in the room; Fₘ is the inner surface area of the envelope enclosure m, with a unit of m²; tₘ(τ) is the temperature of the inner surface m at time τ, with a unit of° C.; tₐ(τ) is the air temperature of the calculated room at the time τ, with a unit of ° C.; M is the number of inner surfaces; q_{cov} is heat transferred from the indoor heat disturbance to the air in a convective manner; qᵥₑₙₜ is a heat transfer amount generated by indoor and outdoor ventilation or ventilation between adjacent rooms, with a unit of W; and fsbₐ is the ratio of convective heat to the total amount of heat dissipation from the heating terminal.

Unknown variables in the boundary equation for the indoor envelope enclosure and the temperature variation equation for the air in the room are separated respectively, and according to the boundary equation for the indoor envelope enclosure and the temperature variation equation for the air in the room after the separation of unknown variables, the room heat balance matrix equation considering the ratio of radiant heat at the heating terminal is constructed as C\dot{T}=AT+Bu, where C represents a matrix for the heat storage capacity of each node, T represents a matrix for temperature of each node, A represents a matrix for the relationship between heat flows of adjacent nodes, B represents a matrix characterizing actions between various heat disturbances and various nodes, and u represents the heat disturbances matrix acting on various nodes.

Matrix B of the envelope enclosure is:

$${B}_{i} = ( \begin{matrix}0 & {h}_{in} {f}_{i} & {h}_{out} {f}_{i} & {fsb}_{j} & {S}_{i} & 0 & 0 & 0 & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{1} & 0 & 0 & 0 & 0 & {k}_{1} & {s}_{si} & {s}_{di} & 0 & 0\end{matrix} ) ,$$

where Bᵢ is matrix B of an envelope enclosure i, hᵢₙfᵢ and hₒᵤₜfᵢ are convection heat transfer of an outer surface of the envelope enclosure i with an adjacent room and outdoor air respectively, fsbⱼ is the ratio of radiant heat obtained by the envelope enclosure i from the heating terminal of the adjacent room to a total amount of heat emitting from the heating terminal of the adjacent room when the adjacent room serves as a heating room, Sᵢ is the solar radiant heat obtained by the outer surface of the envelope enclosure i, kᵢ is indoor heat obtained by the inner surface of the envelope enclosure i, sₛᵢ and s_{di} are scattered heat and direct heat obtained by the inner surface of the envelope enclosure i from the solar radiation through the window respectively, and fsbᵢ is the ratio of radiant heat obtained by the envelope enclosure i to the total amount of heat emitting from the heating terminal,

$${fsb}_{i} = \frac{fsb \cdot \frac{{F}_{z}}{{F}_{fur} + {F}_{z}}}{6} ,$$

where F_{z} is an inner surface area of the envelope enclosure except furniture, and F_{fur} is an equivalent radiation heat transfer surface area of the furniture.

Matrix B of the furniture is:

$${B}_{fur} = ( \begin{matrix}{fsb}_{fur} & 0 & 0 & 0 & {S}_{fur 1} & {k}_{fur 1} & {s}_{s , fur 1} & {s}_{d , fur 1} & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{fur} & 0 & 0 & 0 & {S}_{furn} & {k}_{furn} & {s}_{s , furn} & {s}_{d , furn} & 0 & 0\end{matrix} ) ,$$

where B_{fur} is the matrix B of the furniture, S_{fur1} is solar radiant heat obtained by one side surface of the furniture, S_{furn} is solar radiant heat obtained by the other side surface of the furniture, k_{fur1} is indoor heat obtained by one side surface of the furniture, k_{furn} is indoor heat obtained by the other side surface of the furniture, s_{s, fur1} and s_{d, fur1} are scattered heat and direct heat obtained by one side surface of the furniture from the solar radiation through the window respectively, s_{s, furn} and s_{d, furn} are scattered heat and direct heat obtained by the other side surface of the furniture from the solar radiation through the window respectively, and fsb_{fur} is the ratio of radiant heat obtained by the furniture to the total amount of heat emitting from the heating terminal,

$${fsb}_{fur} = \frac{fsb}{2} \cdot \frac{{F}_{fur}}{{F}_{fur} + {F}_{z}} .$$

Matrix B of the air is: Bₐ=(fsbₐ 0 0 0 0 kₐ 0 0 1 1), where Bₐ is the matrix B of the air, kₐ is indoor heat obtained by the air, and fsbₐ is the ratio of the convection heat transfer amount obtained by the air to the total amount of heat dissipation from the heating terminal, fsbₐ=1−fsb.

The heat disturbance matrix u is:u=(q_{heat supply} t_{air temperature of adjacent room} t_{outdoor temperature} q_{heat supply of adjacent room} q_{solar radiation} q_{internal heat} q_{scattered heat via window} q_{direct heat via window} q_{ventilation of adjacent rooms} q_{outdoor ventilation})^{T}, where q_{heat supply} is heat supply amount from the heating terminal, t_{air temperature of adjacent room} is the air temperature of the adjacent room, t_{outdoor temperature} is the outdoor temperature, q_{heat supply of adjacent room} is heat supply amount from the heating terminal of the adjacent room, q_{solar radiation} is the solar radiant heat, q_{internal heat} is the heat generated in the room except the heating terminal, q_{scattered heat via window} is scattered heat of solar radiation irradiated into the room through the window, q_{direct heat via window} is direct heat of the solar radiation irradiated into the room through the window, q_{ventilation of adjacent rooms} is the heat transfer amount generated by ventilation of the adjacent rooms, and q_{outdoor ventilation} is the heat transfer amount generated by outdoor ventilation.

In element 104, the room heat balance matrix equation is solved according to the ratio of radiant heat at the heating terminal to obtain a room air temperature equation.

In an example, the room air temperature equation is expressed as:

tₐ(τ)=t_{bz}(τ)+φᵥₑₙₜcₚρGₒᵤₜ(τ)(tₒᵤₜ(τ)−tₐ(τ))+Φ_{hvac}Q(τ)

where t_{bz}(τ) is the air temperature of the room without considering heat supply amount from the heating terminal and the natural ventilation at current time, Φᵥₑₙₜ is the influence coefficient of outdoor ventilation on the air temperature at the current time, cₚ and ρ are specific heat and density of the air respectively, Gₒᵤₜ(τ) is the outdoor air ventilation rate, tₒᵤₜ(τ) is the outdoor temperature at the current time, Φ_{hvac} is the influence coefficient of the heat supply amount on the air temperature, and Q(τ) is the heat supply amount emitting from the heating terminal at the current time.

Where,

$$\begin{matrix}{t}_{bz} ( τ ) = {\sum }_{r} {e}^{{λ}_{r} Δ τ} {t}_{ar} ( τ - Δ τ ) \\ + {\sum }_{k} ( {Φ}_{k , 1} {u}_{k} ( τ - Δ τ ) + {Φ}_{k , 0} {u}_{k} ( τ ) ) \\ + {\sum }_{j} ( {Φ}_{j , 1} {t}_{j} ( τ - 2 Δ τ ) + {Φ}_{j , 0} {t}_{j} ( τ - Δ τ ) ) \\ + {\sum }_{j} ( {Φ}_{l , j , 1} {Q}_{j} ( τ - 2 Δ τ ) + {Φ}_{l , j , 0} {Q}_{j} ( τ - Δ τ ) )\end{matrix} ,$$

λᵣ is an eigenvalue obtained by performing orthogonal transformation on an eigenvector of a matrix \sqrt{C}⁻¹A\sqrt{C}⁻¹; tₐᵣ(τ−Δτ) is a component of the air temperature tₐ(τ−Δτ) at previous time, corresponding to λᵣ; uₖ corresponds to a k-th element in the matrix u for heat disturbances, Φ_{k,1} and Φ_{k,0} are the influence coefficients of other heat disturbance acting on the room air temperature at the previous time and the current time respectively, Φ_{j,1} and Φ_{j,0} are first and second influence coefficients of the air temperature of an adjacent room j on the air temperature of the room respectively, tⱼ is the air temperature of the adjacent room j, Φ_{l,j,1} and Φ_{l,j,0} are the first and second influence coefficients of heat supply amount from the adjacent room j on the air temperature of the room respectively, and Qⱼ is the heat supply amount from the heating terminal of the adjacent room j.

In element 105, a heating-terminal thermal characteristic equation is constructed.

In an example, since the heat supply amount is often influenced by the air temperature and the supply water temperature in a common heating terminal, the heating-terminal thermal characteristic equation can be simplified as:

Q(τ)=K(tₚ(τ)−tₐ(τ))

Where Q(τ) is heat supply amount from the heating terminal at the time τ, with a unit of W; K is a complex heat transfer coefficient characterizing the heat transfer capability at the heating terminal, with a unit of W/K; and tₚ(τ) is an equivalent temperature for the heat transfer capability of the heating terminal influenced by supply water temperature and the flow rate.

In element 106, a dynamic simulation equation for the air temperature of the room is determined by integrating the heating-terminal thermal characteristic equation with the room air temperature equation.

In an example, the dynamic simulation equation for the air temperature of the room is expressed as:

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {Kt}_{p} ( τ )}{1 + {Φ}_{vent} {c}_{p} ρ {G}_{out} ( τ ) + {Φ}_{hvac} K} .$$

For different heating terminals, the dynamic simulation equation for the air temperature of the room has different specific forms.

When the heating terminal is a fan coil, the dynamic simulation equation for the air temperature of the room is expressed as:

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} ε {C}_{min} ( τ ) {t}_{g} ( τ )}{1 + {Φ}_{vent} {c}_{p} ρ {G}_{out} ( τ ) + {Φ}_{hvac} ε {C}_{min} ( τ )} ,$$

where ϵ is heat transfer efficiency of the fan coil, Cₘᵢₙ(τ) is the minimum value of the heat capacity of water and air in the fan coil at the time τ, and t_{g}(τ) is the supply water temperature at the time τ.

When the heating terminal is a radiator, the dynamic simulation equation for the air temperature of the room is expressed as:

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {K}^{′} {F}_{r} {t}_{p} ( τ )}{1 + {Φ}_{vent} {c}_{p} ρ {G}_{out} ( τ ) + {Φ}_{hvac} {K}^{′} {F}_{r}} ,$$

where K′ is the complex heat transfer coefficient of the radiator, Fᵣ is the equivalent heat transfer area of the radiator, and tₚ(τ) is the average surface temperature of the radiator at the time τ.

When the heating terminal is a radiant floor, the dynamic simulation equation for the air temperature of the room is expressed as

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {hF}_{f} {t}_{pf} ( τ )}{1 + {Φ}_{vent} {c}_{p} ρ {G}_{out} ( τ ) + {Φ}_{hvac} {hF}_{f}} ,$$

where F_{f} is the equivalent heat transfer area of the radiant floor, t_{pf}(τ) is the average surface temperature of the radiant floor at the time τ, and h is a complex heat transfer coefficient of the radiant floor, h=hᵣ+h_{c}, hᵣ is the equivalent radiation heat transfer coefficient, and h_{c} is the convection heat transfer coefficient.

In element 106, a simulated room air temperature in the building to be simulated is calculated in real time according to real-time heat supply parameters of the heating terminal, such as the meteorological parameters and the heat supply parameters of the adjacent rooms, by using the dynamic simulation equation for the air temperature of the room.

Compared with the conventional systems, the ratio of radiant heat from a heating terminal is used as a variable, to characterize that different heating terminals have different thermal characteristics in heating, due to their different ratios of convection heat to radiation heat. By integrating the thermal equation of the heating terminal with the thermal equation of the building, the thermal characteristics of the heating terminals are combined with thermal characteristics of the building, thereby improving the accuracy of dynamic simulation on the heating system.

According to the present disclosure, characteristics of different heating terminals in the thermal process of the building are characterized by the ratios of convection heat to radiation heat, which makes up for the deficiency that in existing thermal simulation of most buildings, the HVAC action item is only simplified as calculation of convection heat transfer, resulting in a smaller building thermal inertia of the dynamic simulation result compared with the actual measured result. The method effectively improves the accuracy of dynamic simulation of the heating system, and has important application value for optimizing control strategies of the heating system and accurately analyzing the flexibility of passive heat storage of the building, etc.

With a residential building in Beijing as an example for simulation, steps and relevant solutions are described below in detail.

In step I, a physical model for the thermal process of a building is constructed in combination with the ratio of convection heat to radiation heat of a heating terminal. The thermal process of the building mainly includes the heat transfer of the influence factors (such as external disturbances, internal disturbances and adjacent rooms)with the thermal capacitors (such as the envelope enclosure and the air). In addition, heat release of the heating terminal device is emphasized herein, which includes convection heat transfer between the heating terminal and indoor air, and radiation heat transfer between the heating terminal and the inner surface of the building envelope enclosure. Influences of the adjacent room mainly includes convection heat transfer between the outer surface of the partition wall of the calculated room and the air of the adjacent room, and radiation heat transfer between the outer surface of the partition wall of the calculated room and the heating terminal of the adjacent room.

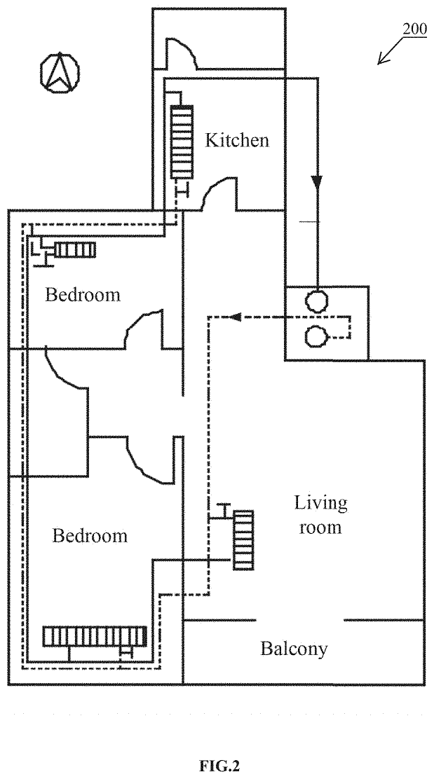

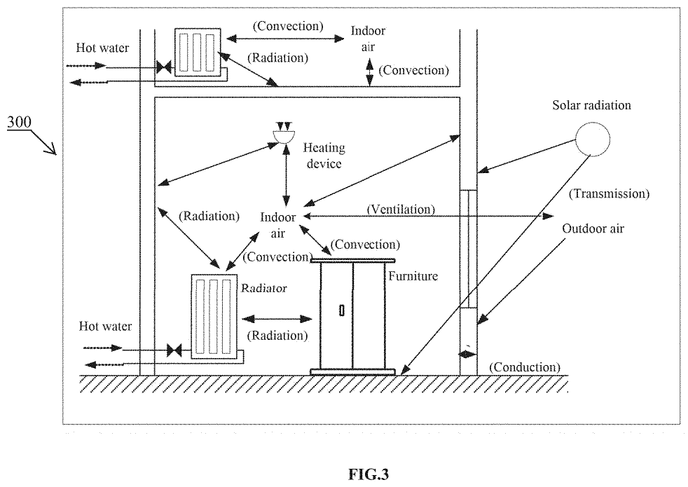

In the embodiment, the residential plan 200 is as shown in FIG. 2, and the constructed room thermophysical model 300 is as shown in FIG. 3.

In the embodiment, there are four stories in a whole building. With a north bedroom on the third floor as an example, the building has the following parameters.

The room has dimensions of 5.0 m×4.0 m×2.8 m. The window-wall ratio of the north exterior wall is 0.3. Thermal parameters of various envelope enclosures are as shown in Table 1 below.

TABLE 1
Thermal parameters of envelope enclosures

| | Exterior | Interior | | | Win- | Furni- |
|---|---|---|---|---|---|---|
| | wall | wall | Roof | Ground | dow | ture |
| Density/(kg/m³) | 1800 | 1800 | 1800 | 1930 | 2500 | 377 |
| Specific heat at | 879 | 879 | 879 | 1010 | 837 | 1930 |
| constant pressure/ | | | | | | |
| (J/(kg · K)) | | | | | | |
| Heat transfer | 0.35 | 2 | 3,08 | 0.93 | 2 | 1 |
| coefficient/ | | | | | | |
| ( W/(m² · K)) | | | | | | |
| Thickness/mm | 370 | 300 | 300 | 1200 | 16 | 100 |

The room is an empty room with a radiator as the heating terminal. The heating terminal is provided with a regulating valve for adjusting with daily schedule, namely the regulating valve is closed from 8:00 to 17:00 every day, and is opened to the maximum at the rest of the time. There are no other indoor heat sources.

In step II, a mathematical model for the thermal process of the building is constructed to obtain a building heat balance matrix equation. A boundary for indoor envelope enclosures is defined as:

$$- λ F \frac{\partial t}{\partial x} {\vert}_{x = l} = {h}_{in} F ( {t}_{a} - t ) + {q}_{r} + {q}_{in} + fsb \cdot {q}_{hvac} . \qquad ( 1 )$$

A temperature variation for air in the room is calculated as:

$${c}_{pa} {ρ}_{a} {V}_{a} \frac{{dt}_{a}}{d τ} = {\sum }_{i = 1}^{n} {F}_{i} {h}_{in} [ {t}_{i} ( τ ) - {t}_{a} ( τ ) ] + {q}_{cov} + {q}_{vent} + {fsb}_{a} {q}_{hvac} , \qquad ( 2 )$$

where Fᵢ is the inner surface area of the envelope enclosure i, with a unit of m²; tᵢ(τ) is the temperature of the inner surface i at time τ, with a unit of ° C.; and n is the number of the inner surfaces.

Further, long-wave radiation heat transfer between the indoor envelope enclosures can be considered. In this case, inner surfaces of the envelope enclosures are obtained by:

$$- λ F \frac{\partial t}{\partial x} {\vert}_{x = l} = {h}_{in} F ( {t}_{a} - t ) + {\sum }_{i} {h}_{r , i} F ( {t}_{i} - t ) + {q}_{r} + {q}_{in} + fsb \cdot {q}_{hvac} , \qquad ( 3 )$$

where h_{r,i} is a long-wave radiation heat transfer coefficient between the inner surfaces of the envelope enclosures, with a dimension same as that of hᵢₙ; and the other variables are the same as above.

A building heat balance equation including the ratio of radiant heat fsb is constructed according to the above contents, and the unknown variables in the equation are separated. With inner surface nodes, internal nodes and outer surface nodes in an i-th n-layer envelope enclosure as an example:

$$\frac{1}{2} {c}_{p 1} {ρ}_{1} Δ {x}_{1} \frac{{dt}_{1}}{d τ} = {h}_{1} ( {t}_{1 , a} - {t}_{1} ) + \frac{{λ}_{1}}{Δ {x}_{1}} ( {t}_{2} - {t}_{1} ) + {q}_{i , r} + {q}_{i , in} + {fsb}_{i} \cdot {q}_{hvac} , \qquad ( 4 )$$

$$\frac{1}{2} ( {c}_{p , m - 1} {ρ}_{m - 1} Δ {x}_{m - 1} + {c}_{p , m} {ρ}_{m} Δ {x}_{m} ) \frac{{dt}_{m}}{d τ} = \frac{{λ}_{m - 1}}{Δ {x}_{m - 1}} ( {t}_{m - 1} - {t}_{m} ) + \frac{{λ}_{m}}{Δ {x}_{m}} ( {t}_{m + 1} - {t}_{m} ) , \qquad ( 5 )$$

$$\frac{1}{2} {c}_{p , n} {ρ}_{n} Δ {x}_{n} \frac{{dt}_{n + 1}}{d τ} = {h}_{n + 1} ( {t}_{n + 1 , a} - {t}_{n + 1} ) + \frac{{λ}_{n}}{Δ {x}_{n}} ( {t}_{n} - {t}_{n + 1} ) + {q}_{i , 0} , \qquad ( 6 )$$

Where c_{p,m}, ρₘ, μₘ, Δ_{Xm} are the specific heat capacity, the density, the thermal conductivity coefficient and the thickness of an m-th layer respectively; q_{i,r}, q_{i,in} are heat gain absorbed by an inner surface of the envelope enclosure i from solar radiation through the window and from the indoor heat disturbance respectively; q_{hvac} is heat supply amount from the heating terminal; fsbᵢ is the ratio of heat supply amount absorbed by the inner surface of the envelope enclosure i from the heating terminal to the total amount of heat supply; and q_{i,o} is heat gain absorbed by an inner surface of the envelope enclosure i from the solar radiation. The window and the furniture have a similar heat balance equation.

A heat balance equation of the air is expressed as:

$${c}_{pa} {ρ}_{a} {V}_{a} \frac{{dt}_{a}}{d τ} = {\sum }_{i} {F}_{i} {h}_{i} ( {t}_{i} - {t}_{a} ) + {\sum }_{j} {c}_{p} ρ {G}_{j} ( {t}_{j} - {t}_{a} ) + {c}_{p} ρ {G}_{o} ( {t}_{o} - {t}_{a} ) + {q}_{cov} + {fsb}_{a} {q}_{hvac} \qquad ( 7 )$$

where hᵢ and tᵢ are convection heat transfer coefficient and the temperature of the inner surface of the envelope enclosure I respectively; Gₒ and Gⱼ are the outdoor air ventilation rate, and the adjacent room j ventilation rate respectively; tₒ and tⱼ are temperatures of the outdoor and the adjacent room j; and other parameters are the same as above.

Accordingly, a building heat balance equation matrix including the ratio fsb of radiant heat is constructed as:

C\dot{T}=AT+Bu (8)

Matrix B of the envelope enclosure i is expressed as:

$${B}_{i} = ( \begin{matrix}0 & {h}_{in} {f}_{i} & {h}_{out} {f}_{i} & {fsb}_{j} & {S}_{i} & 0 & 0 & 0 & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{i} & 0 & 0 & 0 & 0 & {k}_{i} & {s}_{si} & {s}_{di} & 0 & 0\end{matrix} ) . \qquad ( 9 )$$

Matrix B of the furniture is expressed as:

$${B}_{fur} = ( \begin{matrix}{fsb}_{fur} & 0 & 0 & 0 & {S}_{fur 1} & {k}_{fur 1} & {s}_{s , fur 1} & {s}_{d , fur 1} & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{fur} & 0 & 0 & 0 & {S}_{furn} & {k}_{furn} & {s}_{s , furn} & {s}_{d , furn} & 0 & 0\end{matrix} ) \qquad ( 10 )$$

Matrix B of the air is expressed as:

Bₐ=(fsbₐ 0 0 0 0 kₐ 0 0 1 1), (11)

fsbᵢ is the ratio of radiant heat obtained by the envelope enclosure i to the total amount of heat dissipation from the heating terminal.

$${fsb}_{i} = \frac{fsb \cdot \frac{{F}_{z}}{{F}_{fur} + {F}_{z}}}{6} . \qquad ( 12 )$$

The furniture model used herein is a plat-plate model. If the furniture is viewed as a uniform box, the area for receiving radiation of the heating terminal is one-sixth of that of the flat-plate model. In addition, for ease of calculation, the ratio of radiant heat of the envelope enclosure is simplified, and taken as an average value. Considering that the heating terminal is generally installed under an outer window, the radiation heat transfer relationship between the window and the heating terminal is not calculated.

fsb_{fur} is the ratio of radiant heat obtained by the furniture to the total amount of heat emitting from the heating terminal:

$${fsb}_{fur} = \frac{fsb}{2} \cdot \frac{{F}_{fur}}{{F}_{fur} + {F}_{z}} . \qquad ( 13 )$$

fsbₐ is the ratio of a convection heat transfer amount obtained by the air to the total amount of heat dissipation from the heating terminal:

fsbₐ=1−fsb (14)

fsbⱼ is the ratio of radiant heat obtained by the envelope enclosure from a heating terminal of the adjacent room to the total amount of heat emitting from the heating terminal of the adjacent room when the adjacent room serves as a heating room, and is similar to fsbᵢ.

A matrix u for the thermal perturbation is expressed as:

u=(q_{heat supply} t_{air temperature of adjacent room} t_{outdoor temperature} q_{heat supply of adjacent room} q_{solar radiation} q_{internal heat} q_{scatted heat via window} q_{direct heat via window} q_{ventilation of adjacent room} q_{outdoor ventilation})^{T}. (15)

The method of step III is specifically described as follows.

The matrix equation (8) in step II is solved to obtain a dynamic air temperature solution:

tₐ(τ)=t_{bz}(τ)+ΦᵥₑₙₜcₚρGₒᵤₜ(τ)(tₒᵤₜ(τ)−tₐ(τ))+Φ_{hvac}Q(τ) (16)

where t_{bz}(τ) represents the air temperature of the room without considering heat supply amount from the heating terminal and natural ventilation at current time:

$$\begin{matrix}{t}_{bz} ( τ ) = {\sum }_{i} {e}^{{λ}_{i} Δ τ} {t}_{ai} ( τ - Δ τ ) \\ + {\sum }_{k} ( {Φ}_{k , 1} {u}_{k} ( τ - Δ τ ) + {Φ}_{k , 0} {u}_{k} ( τ ) ) \\ + {\sum }_{j} ( {Φ}_{j , 1} {t}_{j} ( τ - 2 Δ τ ) + {Φ}_{j , 0} {t}_{j} ( τ - Δ τ ) ) \\ + {\sum }_{j} ( {Φ}_{l , j , 1} {Q}_{j} ( τ - 2 Δ τ ) + {Φ}_{l , j , 0} {Q}_{j} ( τ - Δ τ ) )\end{matrix} \qquad ( 17 )$$

where λᵢ is an eigenvalue obtained by performing orthogonal transformation on an eigenvector of the matrix \sqrt{C}⁻¹ A\sqrt{C}⁻¹; and tₐᵢ(τ−Δ96 ) is a component of the air temperature tₐ(τ−Δ96 ) at previous time corresponding to λᵢ.

Step IV is specifically described as follows.

A mathematical equation of the heating terminal is constructed. In the common heating terminal, the heat supply amount is often influenced by the room air temperature and the supply water temperature. The mathematical equation can be simplified as:

Q(τ)=K(tₚ(τ)−tₐ(τ)) (18)

By combining equation (16) and equation (18), and integrating the heating terminal equation with the air temperature equation, it can be obtained:

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {Kt}_{p} ( τ )}{1 + {Φ}_{vent} {c}_{p} ρ {G}_{out} ( τ ) + {Φ}_{hvac} K} . \qquad ( 19 )$$

Preferably, different heating terminal models can be selected as required. Simple models including a fan coil, a radiator and a radiant floor are given hereinafter. The radiator is used as the model in the embodiment.

When a fan coil model in an effectiveness-number of transfer units (e-NTU) method is used:

Q(τ)=ϵCₘᵢₙ(τ)|t_{g}(τ)−tₐ(τ)|, (20)

then the air temperature integrated with the heating terminal is:

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} ε {C}_{min} ( τ ) {t}_{g} ( τ )}{1 + {Φ}_{vent} {c}_{p} ρ {G}_{out} ( τ ) + {Φ}_{hvac} ε {C}_{min} ( τ )} . \qquad ( 21 )$$

When the radiator is used,

Q(τ)=KFᵣ(tₚ(τ)−tₐ(τ)), (22)

the air temperature integrated with the heating terminal is

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {KF}_{r} {t}_{p} ( τ )}{1 + {Φ}_{vent} {c}_{p} ρ {G}_{out} ( τ ) + {Φ}_{hvac} {KF}_{r}} . \qquad ( 23 )$$

When the radiant floor is used,

Q(τ)=hFᵣ(t_{pg}(τ)−tₐ(τ)), (24)

the air temperature integrated with the heating terminal is:

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {hF}_{f} {t}_{pf} ( τ )}{1 + {Φ}_{vent} {c}_{p} ρ {G}_{out} ( τ ) + {Φ}_{hvac} {hF}_{f}} , \qquad ( 25 )$$

$$h = {h}_{r} + {h}_{c} . \qquad ( 26 )$$

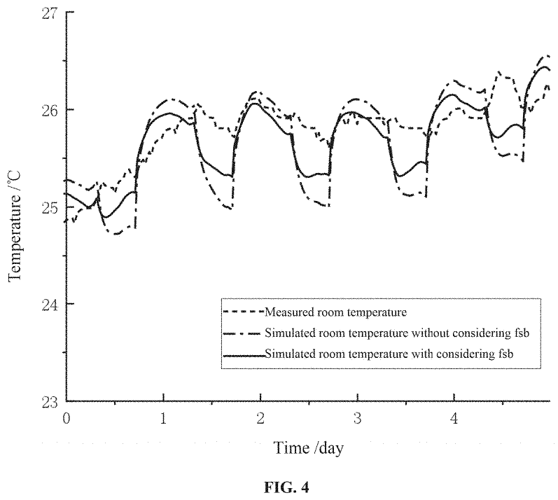

FIG. 4 illustrates a comparison between the simulation result considering or not considering the ratio of convection heat to radiation heat and the measured air temperature in the embodiment. When the ratio of convection heat to radiation heat is not considered, the simulation result has a mean square error (MSE) of 0.1860. When the ratio of convection heat to radiation heat is considered in the method, the simulation result has an MSE of 0.0820. The deviation is reduced significantly.

The embodiment of the present disclosure is intended to provide the method for dynamically simulating the thermal response of a building by integrating the ratio of convection heat to radiation heat of the heating terminal. By introducing a variable “ratio of radiant heat” to characterize different heating terminal, the method constructs a physical model including radiation heat transfer by the heating terminals, and integrates the heating terminal thermal characteristic equation with the building thermal characteristic equation. By constructing a corresponding building thermal characteristic matrix, a dynamic air temperature variation of each room in different operating conditions is solved, which makes up for the shortage of the conventional simulation for thermal performance of buildings, and makes the simulation results more accurate and reliable.

The present disclosure further provides a system for dynamically simulating the thermal response of a building by integrating the ratio of convection heat to radiation heat of the heating terminal, which includes a room thermophysical model, a room heat balance matrix equation determining module, a room air temperature equation obtaining module, a heating-terminal thermal characteristic equation constructing module, an air temperature equation determining module and a simulated room air temperature calculating module.

The room thermophysical model constructing module is configured to construct the room thermophysical model of a building to be simulated, the room thermophysical model includes the radiation heat transfer relationship and the convection heat transfer relationship of the heating terminal in a room.

The room heat balance matrix equation determining module is configured to determine, according to the room thermophysical model, a room heat balance matrix equation considering the ratio of radiant heat from the heating terminal, the ratio of radiant heat is a ratio of radiant heat from the heating terminal to the total amount of heat dissipation.

The room air temperature equation obtaining module is configured to solve the room heat balance matrix equation according to the ratio of radiation heat at the heating terminal to obtain a room air temperature equation.

The heating-terminal thermal characteristic equation constructing module is configured to construct a heating-terminal thermal characteristic equation.

An air temperature equation determining module is configured to determine a dynamic simulation equation for the air temperature of the room by integrating the heating-terminal thermal characteristic equation with the room air temperature equation.

The simulated room air temperature calculating module is configured to calculate the simulated room air temperature in the building to be simulated, in real time according to real-time heat supply parameters of the heating terminal, such as the meteorological parameters and the heat supply parameter of adjacent rooms, and with the dynamic simulation equation for the air temperature of the room.

The room heat balance matrix equation determining module specifically includes the following submodules.

A boundary equation constructing submodule is configured to construct a boundary equation for an indoor envelope enclosure as

$$- λ F \frac{\partial t}{\partial x} {\vert}_{x = l} = {h}_{in} F ( {t}_{a} - t ) + {q}_{r} + {q}_{in} + fsb \cdot {q}_{hvac}$$

according to the room thermophysical model, where λ is the thermal conductivity coefficient of the envelope enclosure along the thickness direction, F is the inner surface area of the envelope enclosure, t is the temperature of the envelope enclosure, x is the thickness, x=l indicates that the thickness value is l, hᵢₙ is the convection heat transfer coefficient between the inner surface of the envelope enclosure and the air, tₐ is the air temperature, qᵣ is the heat absorbed by the inner surface of the envelope enclosure from solar radiation through a window, qᵢₙ is the heat gain absorbed by the inner surface of the envelope enclosure from radiation of the indoor heat disturbance, q_{hvac} is the heat transferred from the heating terminal to the building space, and fsb is the ratio of radiant heat.

A temperature variation equation constructing submodule is configured to construct a temperature variation equation for air in the room as

$${c}_{pa} {ρ}_{a} {V}_{a} \frac{{dt}_{a}}{d τ} = {\sum }_{m = 1}^{M} {F}_{m} {h}_{in} [ {t}_{m} ( τ ) - {t}_{n} ( τ ) ] + {q}_{cov} + {q}_{vent} + {fsb}_{a} {q}_{hvac}$$

according to the room thermophysical model, where cₚₐρₐVₐ is the total heat capacity of the air in the room, cₚₐ is the specific heat capacity of the air in the room, ρₐ is the density of the air in the room, Vₐ is the volume of the air in the room, Fₘ is the inner surface area of the envelope enclosure m, tₘ(τ) is the temperature of the inner surface m at time τ, tₐ(τ) is the air temperature at the time τ, M is the number of inner surfaces, q_{cov} is heat transferred from the indoor heat disturbance to the air in a convective manner, qᵥₑₙₜ is the heat transfer amount generated by outdoor air ventilation or adjacent room air ventilation, and fsbₐ is the ratio of convective heat from the heating terminal to the total amount of heat dissipation from the heating terminal.

A room heat balance matrix equation constructing submodule is configured to separate unknown variables in the boundary equation for the indoor envelope enclosure and the temperature variation equation for the air in the room, and construct, according to the boundary equation for the indoor envelope enclosure and the temperature variation equation for the air in the room after separating unknown variables, the room heat balance matrix equation considering the ratio of radiant heat from the heating terminal as C\dot{T}=AT+Bu, where C represents a matrix for the heat storage capacity of each node, T represents a matrix for the temperature of each node, A represents a matrix for the relationship between heat flows of adjacent nodes, B represents a matrix for interactions between each of heat disturbance and the node, and u represents a matrix for the heat disturbance acting on the node.

Matrix B of the envelope enclosure is

$${B}_{i} = ( \begin{matrix}0 & {h}_{in} {f}_{i} & {h}_{out} {f}_{i} & {fsb}_{j} & {S}_{i} & 0 & 0 & 0 & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{i} & 0 & 0 & 0 & 0 & {k}_{i} & {s}_{si} & {s}_{di} & 0 & 0\end{matrix} ) ,$$

where is matrix Bᵢ of the envelope enclosure i, hᵢₙfᵢ and hₒᵤₜfᵢare the convection heat transfer of the outer surface of the envelope enclosure i with the adjacent room air and the outdoor air respectively, fsbⱼ is the ratio of radiant heat obtained by the envelope enclosure i from the heating terminal of the adjacent room to the total amount of heat emitting from the heating terminal of the adjacent room when the adjacent room serves as a heating room, Sᵢ is solar radiant heat obtained by the outer surface of the envelope enclosure i, kᵢ is indoor heat obtained by the inner surface of the envelope enclosure i, sₛᵢ and s_{di} are scattered heat and direct heat respectively obtained by the inner surface of the envelope enclosure i from the solar radiation through the window, and fsbᵢ is the ratio of radiant heat obtained by the envelope enclosure i to the total amount of heat emitting from the heating terminal,

$${fsb}_{i} = \frac{fsb \cdot \frac{{F}_{z}}{{F}_{fur} + {F}_{z}}}{6} ,$$

F_{z} is the inner surface area of the envelope enclosure except for the furniture, and F_{fur} is the equivalent radiation heat transfer surface area of the furniture.

Matrix B of the furniture is

$${B}_{fur} = ( \begin{matrix}{fsb}_{fur} & 0 & 0 & 0 & {S}_{fur 1} & {k}_{fur 1} & {s}_{s , fur 1} & {s}_{d , fur 1} & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{fur} & 0 & 0 & 0 & {S}_{furn} & {k}_{furn} & {s}_{s , furn} & {s}_{d , furn} & 0 & 0\end{matrix} ) ,$$

where B_{fur} is matrix B of the furniture, S_{fur1} is solar radiant heat obtained by one side surface of the furniture, S_{furn} is solar radiant heat obtained by the other side surface of the furniture, k_{fur1} is indoor heat obtained by the one side surface of the furniture, k_{furn} is indoor heat obtained by the other side surface of the furniture, S_{s, fur1} and s_{d, fur1} are scattered heat and direct heat respectively obtained by one side surface of the furniture from the solar radiation through the window, s_{s, furn} and s_{d, furn} are scattered heat and direct heat respectively obtained by the other side surface of the furniture from the solar radiation through the window, and fsb_{fur} is the ratio of radiant heat obtained by the furniture to the total amount of heat emitting from the heating terminal,

$${fsb}_{fur} = \frac{fsb}{2} \cdot \frac{{F}_{fur}}{{F}_{fur} + {F}_{z}} .$$

Matrix B of the air is Bₐ=(fsbₐ 0 0 0 0 kₐ 0 0 1 1), where Bₐ is matrix B of the air, kₐ is the indoor heat obtained by the air, and fsbₐ is the ratio of the convection heat transfer amount obtained by the air to the total amount of heat dissipation from the heating terminal, fsbₐ=1−fsb.

The heat disturbance matrix u is u=(q_{heat supply} t_{air temperature of adjacent room} t_{outdoor temperature} q_{heat supply of adjacent room} q_{solar radiation} q_{internal heat} q_{scattered heat via window} q_{direct heat via window} q_{ventilation of adjacent room} q_{outdoor ventilation})^{t}, where q_{heat supply} is heat supply amount from the heating terminal, t_{air temperature of adjacent room} is the air temperature of the adjacent room, t_{outdoor temperature} is the outdoor temperature, q_{heat supply of adjacent room} is heat supply amount from the heating terminal of the adjacent room, q_{solar the solar radiant heat, the amount of heat generated in the room except for radiation} is q_{internal heat} is the heating terminal, q_{scattered heat via window} is scattered heat of solar radiation irradiated into the room through the window, q_{direct heat via window} is direct heat of the solar radiation irradiated into the room through the window, q_{ventilation of adjacent room} is the heat transfer amount generated by ventilation of the adjacent room, and q_{outdoor ventilation} is the heat transfer amount generated by outdoor ventilation.

The dynamic simulation equation for the air temperature of the room is expressed as

$${t}_{a} ( τ ) = \frac{{t}_{bz} ( τ ) + {Φ}_{vent} {c}_{p} ρ {G}_{out} ( τ ) {t}_{out} ( τ ) + {Φ}_{hvac} {Kt}_{p} ( τ )}{1 + {Φ}_{vent} {c}_{p} ρ {G}_{out} ( τ ) + {Φ}_{hvac} K} :$$

where tₐ(τ) is the air temperature at the time τ, t_{bz}(τ) is the air temperature of the room without considering heat supply amount from the heating terminal and natural ventilation at current time, Φᵥₑₙₜ is the influence coefficient of outdoor ventilation on the air temperature at the current time, cₚ and ρ are the specific heat and density of the air respectively, Gₒᵤₜ (τ) is the outdoor air ventilation rate, tₒᵤₜ(τ) is the outdoor temperature at the current time, Φ_{hvac} the influence coefficient of the heat supply amount on the air temperature, K is the complex heat transfer coefficient characterizing the heat transfer capability of the heating terminal, and tₚ(τ) is the equivalent temperature for the heat transfer capability of the heating terminal influenced by supply water temperature and the water flow rate.

Various embodiments of the present specification are described in a progressive manner, each embodiment focuses on differences from other embodiments, and the same and similar parts between the embodiments may refer to each other. Since the system disclosed in an embodiment corresponds to the method disclosed in another embodiment, the description is relatively simple, and reference can be made to the method description.

Specific examples are applied herein to explain the principles and implementations of the present disclosure. The foregoing description of the embodiments is merely intended to help understand the method of the present disclosure and its core ideas; besides, various modifications may be made by those in the art to specific implementations and application scope in accordance with the ideas of the present disclosure. In conclusion, the content of the present specification shall not be understood as limiting the present disclosure.

What is claimed is:

1. A method for dynamically simulating a thermal response of a building by integrating a ratio of convection heat to radiation heat of a heating terminal, comprising:
constructing a room thermophysical model of a building to be simulated, the room thermophysical model comprising a radiation heat transfer relationship and a convection heat transfer relationship of the heating terminal in a room;
determining, according to the room thermophysical model, a room heat balance matrix equation considering a ratio of radiant heat from the heating terminal, the ratio of radiant heat being a ratio of radiant heat from the heating terminal to a total amount of heat dissipation from the heating terminal;
solving the room heat balance matrix equation according to the ratio of radiant heat from the heating terminal to obtain a room air temperature equation;
constructing a heating-terminal thermal characteristic equation;
determining a dynamic simulation equation for an air temperature of the room by integrating the heating-terminal thermal characteristic equation with the room air temperature equation; and
calculating a simulated room air temperature in the building to be simulated, in real time, utilizing real-time heat supply parameters of the heating terminal and the dynamic simulation equation for the air temperature of the room.

2. The method according to claim 1, wherein the room thermophysical model comprises heat release of the heating terminal and heat transfer between adjacent rooms;
the heat release of the heating terminal comprises convection heat transfer between the heating terminal and indoor air, and radiation heat transfer between the heating terminal and an inner surface of a building envelope enclosure; and
the heat transfer with the adjacent room comprises convection heat transfer between an outer surface of a partition wall of the room and air of the adjacent room, and radiation heat transfer between the outer surface of the partition wall of the room and a heating terminal of the adjacent room.

3. The method according to claim 1, wherein the determining, according to the room thermophysical model, a room heat balance matrix equation considering a ratio of radiant heat of the heating terminal comprises:
constructing a boundary equation for an indoor envelope enclosure as
$$- λ F \frac{\partial t}{\partial x} {\vert}_{x = l} = {h}_{in} F ( {t}_{a} - t ) + {q}_{r} + {q}_{in} + fsb \cdot {q}_{hvac}$$
according to the room thermophysical model, wherein k is a thermal conductivity coefficient of the envelope enclosure along a thickness direction, F is an inner surface area of the envelope enclosure, t is a temperature of the envelope enclosure, x is a thickness, x=l indicates that a thickness value is l, hᵢₙ is a convection heat transfer coefficient between an inner surface of the envelope enclosure and the air, tₐ is an air temperature, qᵣ is heat absorbed by the inner surface of the envelope enclosure from solar radiation through a window, qᵢₙ is heat gain absorbed by the inner surface of the envelope enclosure from radiation of an indoor thermal disturbance, q_{hvac} is heat transferred from the heating terminal to a building space, and fsb is the ratio of radiant heat;
constructing an air temperature variation equation in the room as
$${c}_{pa} {ρ}_{a} {V}_{a} \frac{{dt}_{a}}{d τ} = {\sum }_{m = 1}^{M} {F}_{m} {h}_{in} [ {t}_{m} ( τ ) - {t}_{a} ( τ ) ] + {q}_{cov} + {q}_{vent} + {fsb}_{a} {q}_{hvac}$$
according to the room thermophysical model, where cₚₐρₐVₐ is a total heat capacity of the air in the room, cₚₐ is a specific heat capacity of the air in the room, ρₐ is a density of the air in the room, Vₐ is a volume of the air in the room, Fₘ is an inner surface area of the envelope enclosure m, tₘ(τ) is a temperature of the inner surface m at time τ, tₐ(τ) is an air temperature at the time τ, M is a number of inner surfaces, q_{cov} is heat transferred from the indoor heat disturbance to the air in a convective manner, qᵥₑₙₜ is a heat transfer amount generated by indoor and outdoor ventilation or ventilation of adjacent rooms, and fsbₐ is a ratio of convective heat from the heating terminal to the total amount of heat dissipation from the heating terminal; and
separating unknown variables in the boundary equation for the indoor envelope enclosure and the temperature variation equation for the air in the room, and constructing, according to the boundary equation for the indoor envelope enclosure and the temperature variation equation for the air in the room after separating the unknown variables, the room heat balance matrix equation considering the ratio of radiant heat from the heating terminal as C\dot{T}=AT+Bu, where C represents a matrix for a heat storage capacity of each node, T represents a matrix for a temperature of each node, A represents a matrix for a relationship between heat flows of adjacent nodes, B represents a matrix for interactions between each heat disturbance and the node, and u represents a matrix for a thermal disturbance acting on each node;
wherein matrix B of the envelope enclosure is:
$${B}_{i} = ( \begin{matrix}0 & {h}_{in} {f}_{i} & {h}_{out} {f}_{i} & {fsb}_{j} & {S}_{i} & 0 & 0 & 0 & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{i} & 0 & 0 & 0 & 0 & {k}_{i} & {s}_{si} & {s}_{di} & 0 & 0\end{matrix} ) ,$$
where Bₜ is matrix B of an envelope enclosure i, hᵢₙfᵢ and hₒᵤₜfᵢ are convection heat transfer of an outer surface of the envelope enclosure i with adjacent room air and outdoor air respectively, fsbⱼ is a ratio of radiant heat obtained by the envelope enclosure i from a heating terminal of the adjacent room to a total amount of heat generated from the heating terminal of the adjacent room when the adjacent room serves as a heating room, Sᵢ is solar radiant heat obtained by the outer surface of the envelope enclosure i, kᵢ is indoor heat obtained by an inner surface of the envelope enclosure i, sₛᵢ and s_{di} are scattered heat and direct heat respectively obtained by the inner surface of the envelope enclosure i from the solar radiation through the window, and fsbᵢ is a ratio of radiant heat obtained by the envelope enclosure i to the total amount of heat emitting from the heating terminal,
$${fsb}_{i} = \frac{fsb \cdot \frac{{F}_{z}}{{F}_{fur} + {F}_{z}}}{6} ,$$
F_{z} is an inner surface area of an envelope enclosure except for furniture, and F_{fur} is n equivalent radiation heat transfer surface area of the furniture;
matrix B of the furniture is:
$${B}_{fur} = ( \begin{matrix}{fsb}_{fur} & 0 & 0 & 0 & {S}_{fur 1} & {k}_{fur 1} & {s}_{s , fur 1} & {s}_{d , fur 1} & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{fur} & 0 & 0 & 0 & {S}_{furn} & {k}_{furn} & {s}_{s , furn} & {s}_{d , furn} & 0 & 0\end{matrix} ) ,$$
where B_{fur} is the matrix B of the furniture, S_{fur1} is solar radiant heat obtained by one side surface of the furniture, S_{furn} is solar radiant heat obtained by another side surface of the furniture, k_{fur1} is indoor heat obtained by one side surface of the furniture, k_{furn} is indoor heat obtained by the other side surface of the furniture, S_{s, fur1} and s_{d, fur1} are scattered heat and direct heat respectively obtained by one side surface of the furniture from the solar radiation through the window, s_{s, furn} and s_{d, furn} are scattered heat and direct heat respectively obtained by the other side surface of the furniture from the solar radiation through the window, and fsb_{fur} is a ratio of radiant heat obtained by the furniture to the total amount of heat emitting from the heating terminal,
$${fsb}_{fur} = \frac{fsb}{2} \cdot \frac{{F}_{fur}}{{F}_{fur} + {F}_{z}} ;$$
matrix B of the air is Bₐ=(fsbₐ 0 0 0 0 kₐ 0 0 1 1), where Bₐ is matrix B of the air, kₐ is indoor heat obtained by the air, and fsbₐ is a ratio of a convection heat transfer amount obtained by the air to the total amount of heat dissipation from the heating terminal, fsbₐ=1−fsb; and
the heat disturbance matrix u is u=(q_{heat supply} t_{air temperature of adjacent room} t_{outdoor temperature} q_{heat supply of adjacent room} q_{solar radiation} q_{internal heat} q_{scattered heat via window} q_{direct heat via window} q_{ventilation of adjacent room} q_{outdoor ventilation})^{T}, where q_{heat supply} is heat supply amount from the heating terminal, t_{air temperature of adjacent room} is an air temperature of the adjacent room, t_{outdoor temperature} is an outdoor temperature, q_{heat supply of adjacent room} is heat supply amount from the heating terminal of the adjacent room, q_{solar radiation} is the solar radiant heat, q_{internal heat} is heat generated in the room except the heating terminal, q_{internal heat is scattered heat via window} is scattered heat of solar radiation irradiated into the room through the window, q_{direct heat via window} is direct heat of the solar radiation irradiated into the room through the window, q_{ventilation of adjacent room} is a heat transfer amount generated by ventilation of the adjacent room, and q_{outdoor ventilation} is a heat transfer amount generated by outdoor ventilation. as:

4. The method according to claim 3, wherein the room air temperature equation is expressed as:
tₐ(τ)=t_{b2}(τ)+ΦᵥₑₙₜcₚρGₒᵤₜ(τ)(tₒᵤₜ(τ)−tₐ(τ))+Φ_{hvac}Q(τ)
Where t_{bz}(τ) is an air temperature of the room without considering heat supply amount from the heating terminal and natural ventilation at current time, Φᵥₑₙₜ is an influence coefficient of outdoor ventilation on the air temperature at the current time, cₚ and ρ are specific heat and a density of the air respectively, Gₒᵤₜ(τ) is an outdoor ventilation rate, tout (τ) is an outdoor temperature at the current time, Φ_{hvac} is an influence coefficient of the heat supply amount on the air temperature of the room, and Q(τ) is heat supply amount from the heating terminal at the current time, where
$${t}_{bz} ( τ ) = {\sum }_{r} {e}^{{λ}_{r} Δτ} {t}_{ar} ( τ - Δτ ) + {\sum }_{k} ( {Φ}_{k , 1} {u}_{k} ( τ - Δτ ) + {Φ}_{k , 0} {u}_{k} ( τ ) ) + {\sum }_{j} ( {Φ}_{j , 1} {t}_{j} ( τ - 2 Δτ ) + {Φ}_{j , 0} {t}_{j} ( τ - Δτ ) ) + {\sum }_{j} ( {Φ}_{l , j , 1} {Q}_{j} ( τ - 2 Δτ ) + {Φ}_{i , j , 0} {Q}_{j} ( τ - Δτ ) ) ,$$
λᵣ is an eigenvalue obtained by performing orthogonal transformation on an eigenvector of a matrix \sqrt{C}⁻¹A\sqrt{C}⁻¹, tₐᵣ(τ−Δτ) is a component of an air temperature tₐ(τ−Δτ) at previous time corresponding to λᵣ, uₖ corresponds to a k-th element in the heat disturbance matrix u, Φ_{k,1} and Φ_{k,0} are influence coefficients of values of other heat disturbance acting on the air temperature of the room at the previous time and the current time respectively, Φ_{j,1} and Φ_{j,0} are first and second influence coefficients of an air temperature of an adjacent room j on the air temperature of the room respectively, tⱼ is the air temperature of the adjacent room j, Φ_{l,j,1} and Φ_{l,j,0} are first and second influence coefficients of heat supply amount from the adjacent room j on the air temperature of the room respectively, and Qⱼ is the heat supply amount from a heating terminal of the adjacent room j.

5. The method according to claim 4, wherein the heating-terminal thermal characteristic equation is expressed as:
Q(τ)=K(tₚ(τ)−tₐ(τ))
Where Q(τ) is the heat supply amount emitting from the heating terminal at the time τ, K is the complex heat transfer coefficient characterizing a heat transfer capability of the heating terminal, and tₚ(τ) is an equivalent temperature for the heat transfer capability of the heating terminal influenced by a supply water temperature and a flow rate.

6. The method according to claim 5, wherein the dynamic simulation equation for the air temperature of the room is expressed as
$${t}_{a} ( τ ) = \frac{{t}_{bz} ( τ ) + {Φ}_{vent} {c}_{p} {ρ G}_{out} ( τ ) {t}_{out} ( τ ) + {Φ}_{hvac} {Kt}_{p} ( τ )}{1 + {Φ}_{vent} {c}_{p} {ρ G}_{out} ( τ ) + {Φ}_{hvac} K} ,$$

7. The method according to claim 6, wherein when the heating terminal is a fan coil, the dynamic simulation equation for the air temperature of the room is expressed as
$${t}_{a} ( τ ) = \frac{{t}_{bz} ( τ ) + {Φ}_{vent} {c}_{p} {ρ G}_{out} ( τ ) {t}_{out} ( τ ) + {Φ}_{hvac} {ε C}_{min} ( τ ) {t}_{g} ( τ )}{1 + {Φ}_{vent} {c}_{p} {ρ G}_{out} ( τ ) + {Φ}_{hvac} {ε C}_{min} ( τ )} ,$$
where ϵ is heat transfer efficiency of the fan coil, Cₘᵢₙ(τ) is a minimum heat capacity of water and air in the fan coil at the time τ, and t_{g}(τ) is a supply water temperature at the time τ;
when the heating terminal is a radiator, the dynamic simulation equation for the air temperature of the room is expressed as
$${t}_{a} ( τ ) = \frac{{t}_{bz} ( τ ) + {Φ}_{vent} {c}_{p} {ρ G}_{out} ( τ ) {t}_{out} ( τ ) + {Φ}_{hvac} {K}^{′} {F}_{r} {t}_{p} ( τ )}{1 + {Φ}_{vent} {c}_{p} {ρ G}_{out} ( τ ) + {Φ}_{hvac} {K}^{′} {F}_{r}} ,$$
where K′ is a complex heat transfer coefficient of the radiator, Fᵣ is an equivalent heat transfer area of the radiator, and tₚ(τ) is an average surface temperature of the radiator at the time τ; and
when the heating terminal is a radiant floor, the dynamic simulation equation for the air temperature of the room is expressed as
$${t}_{a} ( τ ) = \frac{{t}_{bz} ( τ ) + {Φ}_{vent} {c}_{p} {ρ G}_{out} ( τ ) {t}_{out} ( τ ) + {Φ}_{hvac} {hF}_{f} {t}_{pf} ( τ )}{1 + {Φ}_{vent} {c}_{p} {ρ G}_{out} ( τ ) + {Φ}_{hvac} {hF}_{f}} ,$$
where F_{f} is an equivalent heat transfer area of a radiator, t_{pf}(τ) is an average surface temperature of the radiator at the time τ, and h is a complex heat transfer coefficient of the radiant floor, h=hᵣ+h_{c}, hᵣ is an equivalent radiation heat transfer coefficient, and h_{c} is a convection heat transfer coefficient.

8. A system for dynamically simulating a thermal response of a building by integrating a ratio of convection heat to radiation heat of a heating terminal, comprising:
a room thermophysical model constructing module, configured to construct a room thermophysical model of a building to be simulated, the room thermophysical model comprising a radiation heat transfer relationship and a convection heat transfer relationship of the heating terminal in a room;
a room heat balance matrix equation determining module, configured to determine, according to the room thermophysical model, a room heat balance matrix equation considering a ratio of radiant heat from the heating terminal, the ratio of radiant heat being a ratio of radiant heat from the heating terminal to a total amount of heat dissipation from the heating terminal;
a room air temperature equation obtaining module, configured to solve the room heat balance matrix equation according to the ratio of radiant heat from the heating terminal to obtain a room air temperature equation;
a heating-terminal thermal characteristic equation constructing module, configured to construct a heating-terminal thermal characteristic equation;
an air temperature equation determining module, configured to determine a dynamic simulation equation for an air temperature of the room by integrating the heating-terminal thermal characteristic equation with the room air temperature equation; and
a simulated air temperature calculating module, configured to calculate a simulated room air temperature in the building to be simulated in real time, according to real-time heat supply parameters of the heating terminal and with the dynamic simulation equation for the air temperature of the room.

9. The system according to claim 8, wherein the room heat balance matrix equation determining module comprises:
a boundary equation constructing submodule, configured to construct a boundary equation for an indoor envelope enclosure as
$$- λ F \frac{\partial t}{\partial x} {\vert}_{x = l} = {h}_{in} F ( {t}_{a} - t ) + {q}_{r} + {q}_{in} + fsb \cdot {q}_{hvac}$$
according to the room thermophysical model, where λ is a thermal conductivity coefficient of the envelope enclosure along a thickness direction, F is an inner surface area of the envelope enclosure, t is a temperature of the envelope enclosure, x is a thickness, x=l indicates that a thickness value is l, hᵢₙ is a convection heat transfer coefficient between an inner surface of the envelope enclosure and air, tₐ is an air temperature, qᵣ is heat absorbed by the inner surface of the envelope enclosure from solar radiation through a window, q_{in i}s heat gain absorbed by the inner surface of the envelope enclosure from radiation of an indoor heat disturbance, q_{hvac} is heat transferred from the heating terminal to a building space, and fsb is the ratio of radiant heat;
a temperature variation equation constructing submodule, configured to construct a temperature variation equation for air in the room as
$${c}_{pa} {ρ}_{a} {V}_{a} \frac{{dt}_{a}}{d τ} = {\sum }_{m = 1}^{M} {F}_{m} {h}_{in} [ {t}_{m} ( τ ) - {t}_{a} ( τ ) ] + {q}_{cov} + {q}_{vent} + {fsb}_{a} {q}_{hvac}$$
according to the room thermophysical model, where cₚₐρₐVₐ is a total heat capacity of the air in the room, cₚₐ is a specific heat capacity of the air in the room, ρₐ is a density of the air in the room, Vₐ is a volume of the air in the room, Fₘ is an inner surface area of the envelope enclosure m, tₘ(τ) is a temperature of the inner surface m at time τ, tₐ(τ) is an air temperature at the time τ, M is a number of inner surfaces, q_{cov} is heat transferred from the indoor heat disturbance to the air in a convective manner, qᵥₑₙₜ is a heat transfer amount generated by outdoor ventilation or ventilation of an adjacent room, and fsbₐ is a ratio of convective heat from the heating terminal to the total amount of heat dissipation from the heating terminal; and
a room heat balance matrix equation constructing submodule, configured to separate unknown variables in the boundary equation for the indoor envelope enclosure and the temperature variation equation for the air in the room, and construct, according to the boundary equation for the indoor envelope enclosure and the temperature variation equation for the air in the room after separating the unknown variables, the room heat balance matrix equation considering the ratio of radiant heat from the heating terminal as C\dot{T}=At+Bu, where C represents a matrix for a heat storage capacity of each node, T represents a matrix for a temperature of each node, A represents a matrix for a relationship between heat flows of adjacent nodes, B represents a matrix for interactions between each heat disturbance and the node, and u represents a matrix for a heat disturbance acting on the node,
wherein matrix B of the envelope enclosure is
$${B}_{i} = ( \begin{matrix}0 & {h}_{{inf}_{i}} & {h}_{{outf}_{i}} & {fsb}_{j} & {S}_{i} & 0 & 0 & 0 & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{i} & 0 & 0 & 0 & 0 & {k}_{i} & {s}_{si} & {s}_{di} & 0 & 0\end{matrix} ) ,$$
where Bₜ is matrix B of an envelope enclosure i, hᵢₙfᵢ and hₒᵤₜfᵢ are convection heat transfer of an outer surface of the envelope enclosure i with adjacent room air and outdoor air respectively, fsbⱼ is a ratio of radiant heat obtained by the envelope enclosure i from a heating terminal of the adjacent room to a total amount of heat generated from the heating terminal of the adjacent room when the adjacent room serves as a heating room, Sᵢ is solar radiant heat obtained by the outer surface of the envelope enclosure i, k₁ is indoor heat obtained by an inner surface of the envelope enclosure i, sₛᵢ and s_{di} are scattered heat and direct heat respectively obtained by the inner surface of the envelope enclosure i from the solar radiation through the window, and fsbᵢ is a ratio of radiant heat obtained by the envelope enclosure i to the total amount of heat generated from the heating terminal,
$${fsb}_{i} = \frac{fsb \cdot \frac{{F}_{z}}{{F}_{fur} + {F}_{z}}}{6} ,$$
F_{z} is an inner surface area of an envelope enclosure except for the furniture, and F_{fur} is an equivalent radiation heat transfer surface area of the furniture;
matrix B of the furniture is:
$${B}_{fur} = ( \begin{matrix}{fsb}_{fur} & 0 & 0 & 0 & {S}_{fur 1} & {k}_{fur 1} & {s}_{s , fur 1} & {s}_{d , fur 1} & 0 & 0 \\ 0 & 0 & 0 & 0 & 0 & 0 & 0 & 0 & 0 & 0 \\ ⋮ & ⋮ & ⋮ & ⋮ & ⋮ & ⋮ & ⋮ & ⋮ & ⋮ & ⋮ \\ {fsb}_{fur} & 0 & 0 & 0 & {S}_{furn} & {k}_{furn} & {s}_{s , furn} & {s}_{d , furn} & 0 & 0\end{matrix} ) ,$$
where B_{fur} is the matrix B of the furniture, S_{fur1} is solar radiant heat obtained by one side surface of the furniture, S_{furn} is solar radiant heat obtained by an other side surface of the furniture, k_{fur1} is indoor heat obtained by the one side surface of the furniture, k_{furn} is indoor heat obtained by the other side surface of the furniture, s_{s, fur1} and s_{d, fur1} are scattered heat and direct heat respectively obtained by one side surface of the furniture from the solar radiation through the window, s_{s, furn1} and s_{d, furn} are scattered heat and direct heat respectively obtained by the other side surface of the furniture from the solar radiation through the window, and fsb_{fur} is a ratio of radiation heat obtained by the furniture to the total amount of heat generated from the heating terminal,
$${fsb}_{fur} = \frac{fsb}{2} \cdot \frac{{F}_{fur}}{{F}_{fur} + {F}_{z}} ;$$
matrix B of the air is Bₐ=(fsbₐ 0 0 0 0 kₐ 0 0 1 1), where Bₐ is the matrix B of the air, kₐ is indoor heat obtained by the air, and fsbₐ is a ratio of a convection heat transfer amount obtained by the air to the total amount of heat dissipation from the heating terminal, fsbₐ=1−fsb; and
the heat disturbance matrix u is u=(q_{heat supply} t_{air temperature of adjacent room} t_{outdoor temperature} q_{heat supply of adjacent rooms} q_{solar radiation} q_{internal heat} q_{scattered heat via window} q_{direct heat via window} q_{ventilation of adjacent room} q_{outdoor ventilation})^{T}, where q_{heat supply} is heat supply amount from the heating terminal, t_{air temperature of adjacent room} is an air temperature of the adjacent room, t_{outdoor temperature} is an outdoor temperature, q_{heat supply of adjacent room} is heat supply amount from the heating terminal of the adjacent room, q_{solar radiation} is the solar radiant heat, q_{internal heat} is an amount of heat generation in the room except for the heating terminal, q_{scattered heat via window} is scattered heat in solar radiation irradiated into the room through the window, q_{direct heat via window} is direct heat in the solar radiation irradiated into the room through the window, q_{ventilation of adjacent room i}s a heat transfer amount generated by ventilation of the adjacent room, and q_{outdoor ventilation} is a heat transfer amount generated by outdoor ventilation.

10. The system according to claim 9, wherein the dynamic simulation equation for the air temperature of the room is expressed as:
$${t}_{a} ( τ ) = \frac{{t}_{bz} ( τ ) + {Φ}_{vent} {c}_{p} {ρ G}_{out} ( τ ) {t}_{out} ( τ ) + {Φ}_{hvac} {Kt}_{p} ( τ )}{1 + {Φ}_{vent} {c}_{p} {ρ G}_{out} ( τ ) + {Φ}_{hvac} K} ,$$
where tₐ(τ) is the air temperature at the time τ, t_{bz}(τ) is a temperature of the room without considering heat supply amount from the heating terminal and natural ventilation at current time, Φᵥₑₙₜ is an influence coefficient of outdoor ventilation on the air temperature at the current time, cₚ and ρ are specific heat and a density of the air respectively, Gₒᵤₜ(τ) is outdoor ventilation rate, tₒᵤₜ(τ) is an outdoor temperature at the current time, Φ_{hvac} is an influence coefficient of the heat supply amount on the air temperature, K is a complex heat transfer coefficient characterizing a heat transfer capability of the heating terminal, and tₚ(τ) is an equivalent temperature for the heat transfer capability of the heating terminal influenced by the supply water temperature and a flow rate.
